(19) United States
(12) Patent Application Publication
(10) Pub. No.: US 2025/0265472 A1
(43) Pub. Date: Aug. 21, 2025

(54) DIFFUSION-REWARD ADVERSARIAL IMITATION LEARNING

(71) Applicant: NVIDIA Corporation, Santa Clara, CA (US)

(72) Inventors: Min-Hung Chen, Zhubei City (TW); Yu-Chiang Wang, Taipei City (TW); Hsiang-Chun Wang, Taipei City (TW); Chun-Mao Lai, Tainan City (TW); Shao-Hua Sun, Taipei City (TW)

(21) Appl. No.: 18/986,513

(22) Filed: Dec. 18, 2024

Related U.S. Application Data
(60) Provisional application No. 63/556,294, filed on Feb. 21, 2024.

(51) Int. Cl. G06N 3/092

(52) U.S. Cl. CPC G06N 3/092

(57) ABSTRACT

Imitation learning, or artificial intelligence-based learning from demonstration, aims to acquire an agent policy by observing and mimicking the behavior demonstrated in expert demonstrations. Imitation learning can be used to generate reliable and robust learned policies in a variety of tasks involving sequential decision-making, such as autonomous driving and robotics tasks. However, current imitation learning solutions are limited in their ability to generalize states or goals unseen from the expert's demonstrations. The present disclosure integrates a diffusion model into generative adversarial imitation learning, which, in terms of prior solutions, can provide superior performance in generalizing to states or goals unseen from the expert's demonstrations, provide data efficiency for varying the amounts of available expert data, and capture more robust and smoother rewards.

### CLAIM OF PRIORITY

This application claims the benefit of U.S. Provisional Application No. 63/556,294 (Attorney Docket No. NVIDP1394+/24−TP-0201US01) titled “DIFFUSION REWARDS GUIDED ADVERSARIAL IMITATION LEARNING,” filed Feb. 21, 2024, the entire contents of which is incorporated herein by reference.

### TECHNICAL FIELD

The present disclosure relates to artificial intelligence-based imitation learning.

### BACKGROUND

Imitation learning, or artificial intelligence-based learning from demonstration, aims to acquire an agent policy by observing and mimicking the behavior demonstrated in expert demonstrations. Various imitation learning methods have enabled deploying reliable and robust learned policies in a variety of tasks involving sequential decision-making, especially in the scenarios where devising a reward function is intricate or uncertain, or when learning in a trial-and-error manner is expensive or unsafe.

Among various methods in imitation learning, generative adversarial imitation learning (GAIL) has been widely adopted due to its effectiveness and data efficiency. GAIL learns a generator policy to imitate expert behaviors through reinforcement learning and a discriminator to differentiate between the expert and the generator's state-action pair distributions, resembling the idea of generative adversarial networks (GANs). Despite its established theoretical guarantee, GAIL training is notoriously brittle and unstable. To alleviate this issue, significant efforts have been put into improving GAIL's sample efficiency, scalability, robustness, and generalizability by modifying loss functions, developing improved policy learning algorithms, and exploring various similarity measures of distributions.

However, current solutions are still limited in their ability to generalize states or goals unseen from the expert's demonstrations. Further, these solutions are limited in their ability to provide robust and smooth rewards.

There is a need for addressing these issues and/or other issues associated with the prior art. For example, there is a need to integrate a diffusion model into generative adversarial imitation learning, which, in terms of prior solutions, can provide superior performance in generalizing to states or goals unseen from the expert's demonstrations, provide data efficiency for varying the amounts of available expert data, and capture more robust and smoother rewards.

### SUMMARY

A method, computer readable medium, and system are disclosed for training a policy to imitate expert behaviors included in at least one expert demonstration. The policy generates an action for an input state to generate a state-action pair. A diffusion model is used to process the state-action pair to generate a reward signal indicating a fitness of the state-action pair to the expert behaviors. In an embodiment, a diffusion discriminative classifier, which is based on the diffusion model, generates the reward signal. The policy updates one or more policy parameters based on the reward signal.

### BRIEF DESCRIPTION OF THE DRAWINGS

FIG. 1 illustrates a flowchart of a method for training a policy to imitate expert behaviors included in at least one expert demonstration, in accordance with an embodiment.

FIG. 2 illustrates a system framework for training a diffusion discriminative classifier, in accordance with an embodiment.

FIG. 3 illustrates a system framework for learning a policy using the diffusion discriminative classifier of FIG. 2, in accordance with an embodiment.

FIG. 4 illustrates a flowchart of a method for using a policy trained to imitate expert behaviors, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

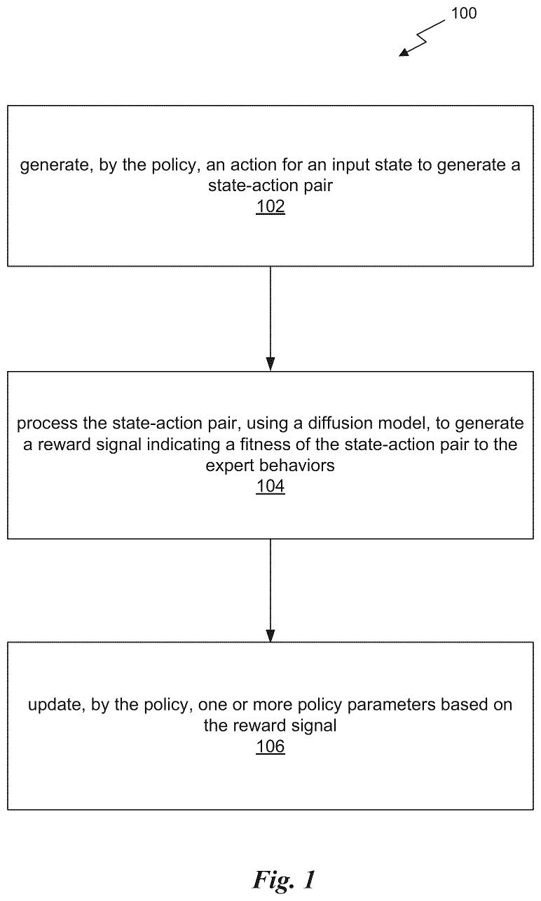

FIG. 1 illustrates a flowchart of a method 100 for training a policy to imitate expert behaviors included in at least one expert demonstration, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

As mentioned above, the method 100 is performed for training a policy to imitate expert behaviors. The policy refers to a set of rules or strategies that defines the decision-making process of an agent to achieve an objective. Accordingly, the policy may be referred to as an agent policy. Given an input state, the policy is configured to generate the action to be taken by the agent. In an embodiment, the policy may be initialized prior to the training. Such initialization may allow the policy to generate actions for given states, even prior to the training disclosed herein.

The policy in particular is trained through machine learning to imitate the expert behaviors, and therefore the policy may be a machine learning model. Expert behaviors refer to the actions taken by an expert at various states, which in combination represent an optimal or targeted decision-making process to achieve the objective. In the context of the present description, the expert behaviors are included in at least one expert demonstration.

In an embodiment, the at least one expert demonstration includes a recording of an expert performing a task (i.e. to achieve the objective). In an embodiment, the at least one expert demonstration is represented by expert data that includes a set of data points. Each data point in the set of data points may consist of expert state-action pairs, with each such pair including a state and an action taken by the expert in the state.

The method 100 may be repeated over multiple iterations to train the policy. Thus, the policy may be incrementally optimized toward imitating the expert behaviors. In a first iteration of the method 100, the initialized version of the policy may be employed. The method 100 may be repeated until an optimization objective has been met.

Returning to the method 100, in operation 102, the policy generates an action for an input state to generate a state-action pair. In particular, a state is input to the policy to cause the policy to generate the action for the state. The input state and the generated action represent the state-action pair. As mentioned above, in a first training iteration, an initialized version of the policy may be used to generate the state-action pair.

In operation 104, a diffusion model is used to process the state-action pair to generate a reward signal indicating a fitness of the state-action pair to the expert behaviors. The diffusion model refers to a machine learning model that has been trained to gradually remove noise added to data points, and thus at inference time a diffusion process of the model denoises a given input over one or more steps. The noise refers to (e.g. random or pseudo-random) artifacts that are present in the data.

In an embodiment, a diffusion process of the diffusion model may be used to denoise the state-action pair. In an embodiment, the reward signal may be generated from the denoised state-action pair output by the diffusion model. In an embodiment, the diffusion model may form the denoised state-action pair via a single step of the diffusion process.

In an embodiment, the diffusion model is a component of a diffusion discriminative classifier, such that the reward signal is generated by the diffusion discriminative classifier via the diffusion model. In an embodiment, the reward signal may be generated by (1) computing a first diffusion loss that measures a fitness of the denoised state-action pair to a distribution of the expert behaviors, (2) computing a second diffusion loss that measures a fitness of the denoised state-action pair to a distribution of agent behaviors, and (3) computing the reward signal based on the first diffusion loss and the second diffusion loss. In an embodiment, the reward signal may be computed within a range bounded by a first value and a second value. In an embodiment, the first value may be indicative of a fitness to the distribution of the expert behaviors and the second value may be indicative of a fitness to the distribution of the agent behaviors.

In an embodiment, the method 100 may comprise training the diffusion model for use in generating a reward signal for a given state-action pair. In this embodiment, the diffusion model may be trained on expert data that includes a set of expert data points, wherein each expert data point in the set of expert data points consists of expert state-action pairs each including a state and an action taken by an expert in the state, and agent data that includes a set of agent data points, wherein each agent data point in the set of agent data points consists of agent state-action pairs each including a state and an action taken by an agent in the state. In an embodiment, the diffusion model may be trained to distinguish the expert data from the agent data.

In an embodiment, for each input expert state-action pair, the diffusion model may generate a denoised expert state-action pair, and further a first diffusion loss is computed that measures a fitness of the denoised expert state-action pair to a distribution of the expert data, a second diffusion loss may be computed that measures a fitness of the denoised expert state-action pair to a distribution of the agent data, and the first diffusion loss and the second diffusion loss may be integrated to compute a value of the expert state-action pair within a range bounded by a first value and a second value, where the first value is indicative of a fitness to the distribution of the expert data and the second value is indicative of a fitness to the distribution of the agent data. In an embodiment, for each input agent state-action pair, the diffusion model may generate a denoised agent state-action pair, and further a third diffusion loss may be computed that measures a fitness of the denoised agent state-action pair to a distribution of the agent data, a fourth diffusion loss may be computed that measures a fitness of the denoised agent state-action pair to a distribution of the agent data, and the third diffusion loss and the fourth diffusion loss may be integrated to compute a value of the agent state-action pair within the range bounded by the first value and the second value. In an embodiment, additionally for each input expert state-action pair, an expert binary cross-entropy loss may be computed from the value of the expert state-action pair, and parameters of the diffusion model may be updated based on the expert binary cross-entropy loss. In an embodiment, additionally for each input agent state-action pair, an agent binary cross-entropy loss may be computed from the value of the agent state-action pair, and the parameters of the diffusion model may be updated based on the agent binary cross-entropy loss.

Following the generation of the reward signal in operation 104, the policy updates one or more policy parameters based on the reward signal in operation 106. The policy parameters refer to one or more adjustable parameters of the policy. In an embodiment, the one or more policy parameters may be updated to maximize the reward signal.

To this end, the method 100 integrates the diffusion model into the training process for a policy aimed at imitating expert behaviors. In an embodiment, the policy may be trained for a single task. In this embodiment, the expert behaviors that the policy is trained to imitate may demonstrate the single task. In another embodiment, the policy may be trained for a plurality of different tasks. In this embodiment, the expert behaviors that the policy is trained to imitate may demonstrate the plurality of different tasks.

In one embodiment the policy may be trained for at least one robotics task. The robotic task(s) may include gripping, pushing, moving, etc. of objects, for example. In another embodiment, the policy may be trained for at least one autonomous driving task. For example, the autonomous driving task(s) may include accelerating, decelerating, stopping, turning, merging, etc.

In an embodiment, the method 100 may further comprise deploying the trained policy for use by a downstream application to generate actions for given states. In this embodiment, the application may input a detected state to the policy to generate an action which the application then cause to be taken. In an embodiment, the downstream application may include a robotics application. In another embodiment, the downstream application may include an autonomous driving application.

Further embodiments will now be provided in the description of the subsequent figures. It should be noted that the embodiments disclosed herein with reference to the method 100 of FIG. 1 may apply to and/or be used in combination with any of the embodiments of the remaining figures below.

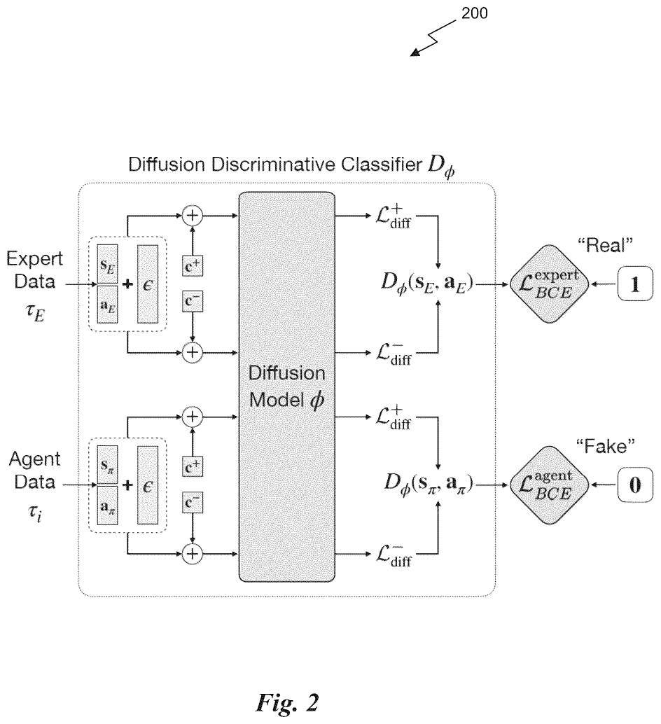

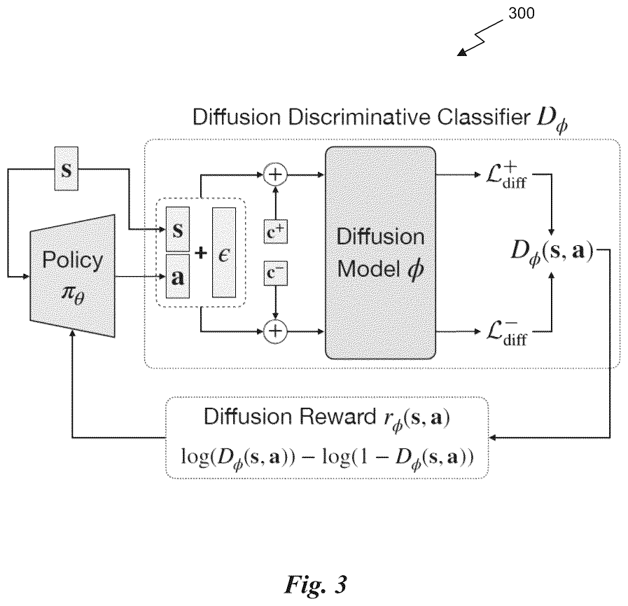

FIG. 2 illustrates a system framework 200 for training a diffusion discriminative classifier, in accordance with an embodiment. The trained diffusion discriminative classifier may then be used with the system framework 300 of FIG. 3 to train a policy, as described in detail below.

The system framework 200 aims to generate a diffusion discriminative classifier that yields a diffusion model reward given an agent state-action pair without going through the entire diffusion generation process. In other words, once trained, the diffusion discriminative classifier operates to extract the learning signal from a portion of the diffusion denoising steps, rather than using the entire process. In an embodiment, the diffusion discriminative classifier may be configured to provide a binary classification signal using just one denoising step.

In general, a diffusion loss (i.e., the difference between the predicted noise and the injected noise) indicates how well the data fits the target distribution since the diffusion loss is the upper bound of the negative log-likelihood of data in the target distribution. The present system framework 200 is configured to calculate “realness” rewards based on the diffusion loss computed by denoising the state-action pairs from the policy, which indicates how well the state-action pairs fit the expert behavior distributions. The diffusion loss [symbol] _{diff} is formulated per Equation 1.

$${ℒ}_{diff} ( s , a , c ) = {𝔼}_{t \sim T} [ {‖ {ϵ}_{∅} ( s , a , ϵ , t \vert c ) - ϵ ‖}^{2} ] \qquad Equation 1$$

where c∈{c⁺, c⁻}, and the real label c⁺ corresponds to the condition for fitting expert data while the fake label c⁻ corresponds to agent data. In an embodiment, c⁺ is implemented as 1 and c⁻ as 0.

To approximate the expectation in Equation 1, random sampling is used, which achieves the result with just a single denoising step. Subsequently, given a state-action pair (s, a), [symbol] _{diff} (s, a, c⁺) measures how well (s, a) fits the expert distribution and [symbol] _{diff} (s, a, c⁻) measures how well (s, a) fits the agent distribution. For simplicity, the notations [symbol] _{diff}⁺ and [symbol] _{diff}⁻ will be used hereinbelow to represent [symbol] _{diff} (s, a, c⁺) and [symbol] _{diff} (s, a, c⁻), respectively. Additionally, [symbol] _{diff}^{+,-} denotes [symbol] _{diff}⁺ and [symbol] _{diff}⁻ given a state-action pair. Given state-action pairs sampled from an expert demonstration, [symbol] _{diff}⁺ should be close to 0, and [symbol] _{diff}⁻ should be a large value; on the contrary, given agent state-action pairs, [symbol] _{diff}⁺ should be a large value and [symbol] _{diff}⁻ should be close to 0, and [symbol] _{diff}⁻.

While [symbol] _{diff}⁺ and [symbol] _{diff}⁻ can indicate the “realness” or the “fakeness” of a state-action pair to some extent, optimizing a policy (per system framework 300 of FIG. 3) using rewards with this wide value range [0,∞) can be difficult. To address this issue, the diffusion model is transformed into a binary classifier that provides “realness” in a bounded range of [0, 1]. Specifically given the diffusion model's output [symbol] _{diff}^{+,-}, a diffusion discriminative classifier D_{Ø}: S×A→ [symbol] is constructed per Equation 2.

$${D}_{∅} ( s , a ) = \frac{{e}^{- {ℒ}_{diff} ( s , a , {c}^{+} )}}{{e}^{- {ℒ}_{diff} ( s , a , {c}^{+} )} + {e}^{- {ℒ}_{diff} ( s , a , {c}^{-} )}} = σ ( {ℒ}_{diff} ( s , a , {c}^{-} ) - {ℒ}_{diff} ( s , a , {c}^{+} ) ) \qquad Equation 2$$

where σ(x)=1/(1+e^{-x}) denotes the sigmoid function. The classifier integrates [symbol] _{diff}⁺ and [symbol] _{diff}⁻ to compute the “realness” of a state-action pair within a bounded range of [0, 1]. Based on the design of the diffusion discriminative classifier, learning a policy with the classifier (as described with respect to the system framework 300 of FIG. 3 below) allows for optimizing this objective to bring a policy's occupancy measure closer to the expert's. Consequently, the proposed diffusion discriminative classifier D_{Ø} can be optimized with the loss function in Equation 3.

$${ℒ}_{D} = {𝔼}_{( s , a ) ∈ {τ}_{E}} {\underbrace{[ - log ( {D}_{∅} ( s , a ) ) ]}}_{{ℒ}_{BCE}^{expert}} + {𝔼}_{( s , a ) ∈ {τ}_{i}} {\underbrace{[ - log ( {D}_{∅} ( s , a ) ) ]}}_{{ℒ}_{BCE}^{agent}} \qquad Equation 3$$

where [symbol] _{D} sums the expert binary cross-entropy loss [symbol] _{BCE}^{expert} and the agent binary cross-entropy loss [symbol] _{BCE}^{agent} E, and τ_{E} and τᵢ represent a sampled expert trajectory and a collected agent trajectory by the policy 7L at training step i. The diffusion discriminative classifier parameters ϕ are then updated based on the gradient of [symbol] _{D} to improve its ability to distinguish expert data from agent data.

The discriminator D_{Ø} is trained to predict a value closer to 1 when the input state-action pairs are sampled from expert demonstration (i.e., trained to minimize [symbol] _{diff}⁺ and maximize [symbol] _{diff}⁻), and 0 if the input state-action pairs are obtained from the agent online interaction (i.e., trained to minimize [symbol] _{diff}⁻ and maximize [symbol] _{diff}⁺). To this end, instead of optimizing the diffusion loss [symbol] _{diff}, the binary cross entropy losses calculated based on the denoising results are directly optimized to train the diffusion model as a binary classifier.

FIG. 3 illustrates a system framework 300 for learning a policy using the diffusion discriminative classifier of FIG. 2, in accordance with an embodiment.

The system framework 300 operates to update the discriminator and a policy alternately. In the discriminator step, the diffusion discriminative classifier (trained per the system framework 200 of FIG. 2) is updated with the gradient of [symbol] _{D} per Equation 3. In the policy step, an adversarial inverse reinforcement learning objective is adopted as the diffusion reward signal to train the policy, per Equation 4.

$${r}_{ϕ} ( s , a ) = log ( {D}_{ϕ} ( s , a ) ) - log ( 1 - {D}_{ϕ} ( s , a ) ) \qquad Equation 4$$

The policy parameters θ can be updated using a reinforcement learning algorithm to maximize the diffusion rewards provided by the diffusion discriminative classifier, bringing the policy closer to the expert policy. In an embodiment, proximal policy optimization may be used as the policy update algorithm. An embodiment of the algorithm is presented in Table 1, which may be implemented as illustrated in FIG. 3.

TABLE 1
1: Input: Expert trajectories τ_{E} , initial policy parameters θ₀, initial diffusion
discriminator parameters ϕ₀, and discriminator learning rate η_{ϕ}
2: for i = 0, 1, 2, . . . do
3: Sample agent transitions τᵢ ~ π_{θ}_{ᵢ}
4: Compute the output of diffusion discriminative classifier D_{ϕ} (Equation 2) and
the loss function [symbol] _{D} (Equation 3)
5: Update the diffusion model ϕᵢ₊₁ ← ϕᵢ − η_{ϕ} ∇ [symbol] _{D}
6: Compute the diffusion reward r_{ϕ}(s, a) with Equation 4
7: Update the policy θᵢ₊₁ ← θᵢ with a reinforcement learning algorithm with
respect to reward r_{ϕ}
8: end for

The presently disclosed system framework 300 improves upon prior solutions that employ an unconditional diffusion model to denoise state-action pairs from both experts and agents, at least in part because those solutions only implicitly reflects the likelihood of state-action pairs belonging to the expert class through diffusion loss, making it challenging to explicitly distinguish between expert and agent behaviors. In contrast, the presently disclosed system framework 300 uses a conditional diffusion model that directly conditions real (c⁺) and fake (c⁻) labels, which allows the model to explicitly calculate and compare the probabilities of state-action pairs belonging to either the expert or agent class. This signal for binary classification is clearer and more robust to input noise, and further aligns more closely with the objectives of the system framework 300 as a whole, leading to more stable and efficient learning of the policy.

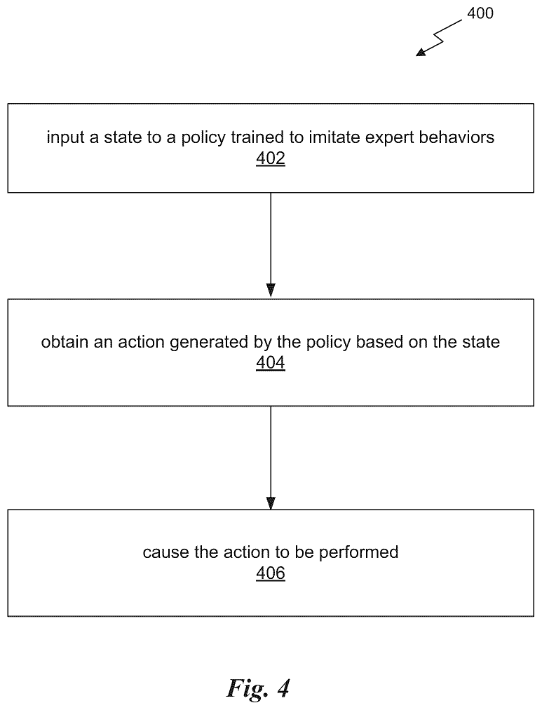

FIG. 4 illustrates a flowchart of a method 400 for using a policy trained to imitate expert behaviors, in accordance with an embodiment. With respect to the present embodiment, the policy has been trained per the method 100 of FIG. 1 and/or the system framework 300 of FIG. 3. In an embodiment, the policy is deployed (e.g. to a cloud server, datacenter, etc.) for use thereof. In an embodiment, an application may perform the method 400 to use the policy for one or more application-specific tasks.

In operation 402, a state is input to the policy trained to imitate expert behaviors. The state refers to the state of an agent. For example, the state may be a configuration, location, current behavior, etc. of the agent.

In operation 404, an action generated by the policy based on the state is obtained. The action refers to an action to be taken by the agent. The action is predicted by the policy as one that mimics an expert behavior with respect to the input state. In some examples, the action may be for the agent to change the configuration, change the location, change the current behavior, etc.

In operation 406, the action is caused to be performed. In an embodiment, performing the action may cause the agent to perform a task. For example, the action may be performed to cause the agent to perform an autonomous driving task or a robotics task.

In an embodiment, performing the action may cause the agent to be placed in a new state. In an embodiment, the method 100 may be repeated for the new state. In this way, actions of the agent may be controlled using the policy.

In embodiments, the policy may be trained for a single task or for a plurality of different tasks. Accordingly, in an embodiment, the method 100 may be performed (and optionally repeated) for the agent to complete the single task. In another embodiment, the method 100 may be performed and repeated for the agent to complete two or more of the plurality of different tasks.

### Exemplary Use Case—Autonomous Driving Application

In an embodiment, the method 100 may be performed by an autonomous driving application that is being used to control operations of an autonomous driving vehicle. In this exemplary embodiment, the autonomous driving application inputs a state of the autonomous driving vehicle (e.g. location, speed, environment, etc.) to the policy. The policy processes the state to generate an action for the autonomous driving vehicle (e.g. stopping, accelerating, deceleration, changing lanes, etc.). The autonomous driving application causes the autonomous driving vehicle to perform the action.

### Exemplary Use Case—Robotics Application

In an embodiment, the method 100 may be performed by a robotics application that is being used to control operations of a robot. In this exemplary embodiment, the robotics application inputs a state of the robot (e.g. configuration, location, environment, etc.) to the policy. The policy processes the state to generate an action for the robot (e.g. gripping, moving, pushing, etc.). The robotics application causes the robot to perform the action.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

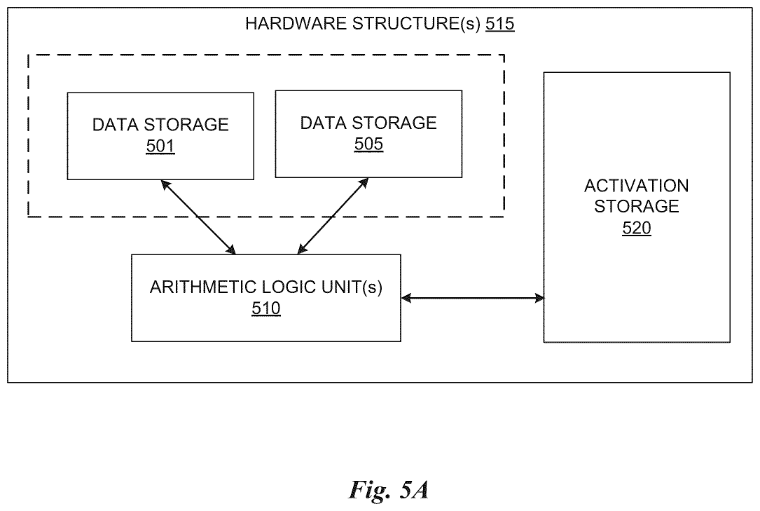

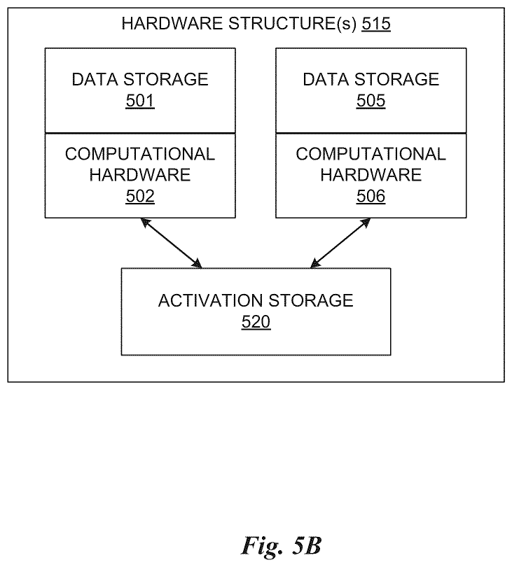

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

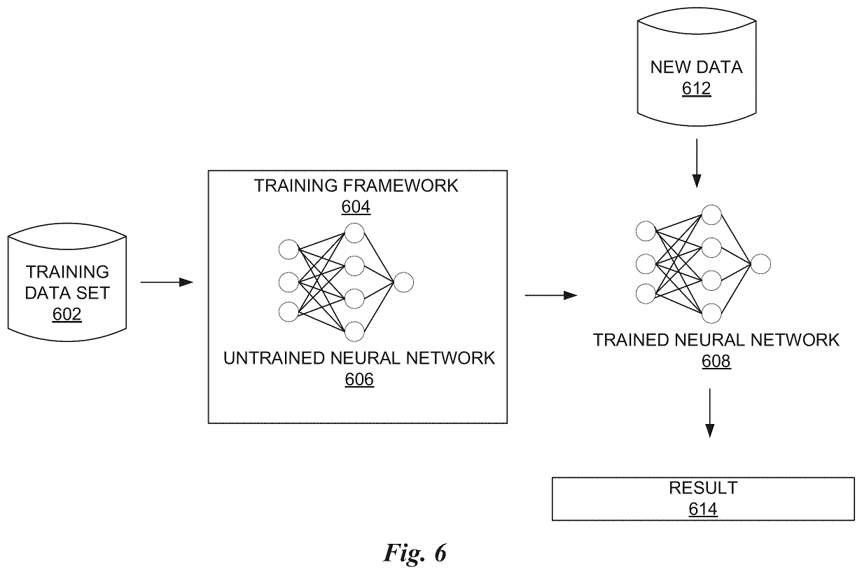

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

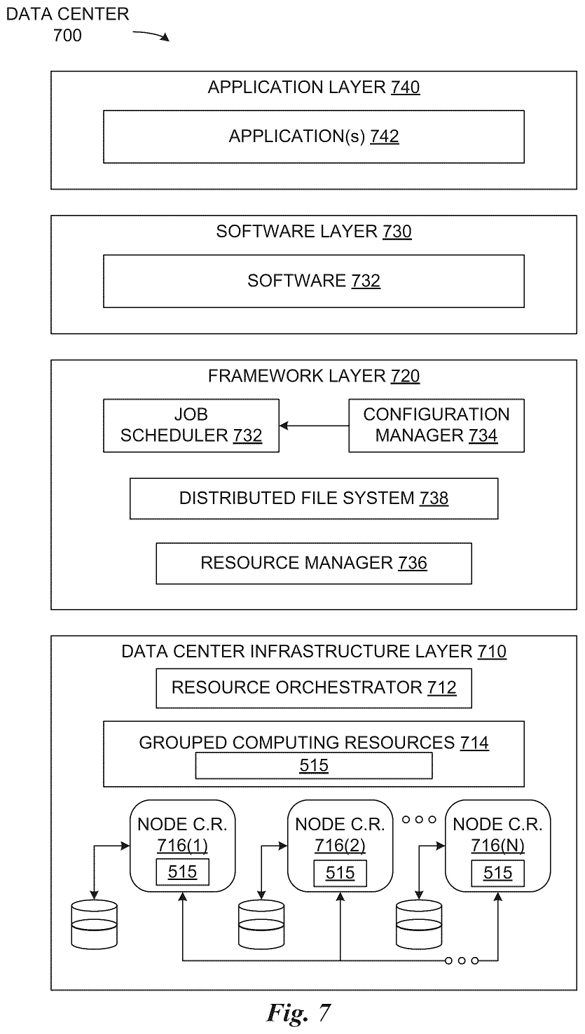

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide a policy that imitates expert behavior. In accordance with FIGS. 1-4, embodiments may provide a diffusion model and a policy each usable for performing inferencing operations and for providing inferenced data. The diffusion model and/or policy may be stored (partially or wholly) in one or both of data storage 501 and 505 in inference and/or training logic 515 as depicted in FIGS. 5A and 5B. Training and deployment of the diffusion model and/or policy may be performed as depicted in FIG. 6 and described herein. Distribution of the diffusion model and/or policy may be performed using one or more servers in a data center 700 as depicted in FIG. 7 and described herein.

What is claimed is:

1. A method, comprising:
at a device, training a policy to imitate expert behaviors included in at least one expert demonstration by:
generating, by the policy, an action for an input state to generate a state-action pair;
processing the state-action pair, using a diffusion model, to generate a reward signal indicating a fitness of the state-action pair to the expert behaviors; and
updating, by the policy, one or more policy parameters based on the reward signal.

2. The method of claim 1, wherein the policy is a machine learning model.

3. The method of claim 1, wherein the at least one expert demonstration includes a recording of an expert performing a task.

4. The method of claim 3, wherein the at least one expert demonstration is represented by expert data that includes a set of data points, wherein each data point in the set of data points consists of expert state-action pairs each including a state and an action taken by the expert in the state.

5. The method of claim 1, wherein the policy is initialized prior to the training.

6. The method of claim 1, wherein the reward signal is generated by a diffusion discriminative classifier that includes the diffusion model.

7. The method of claim 6, wherein the reward signal is generated from a denoised state-action pair output by the diffusion model.

8. The method of claim 7, wherein the diffusion model forms the denoised state-action pair via a single step of a diffusion process.

9. The method of claim 8, wherein the reward signal is generated by:
computing a first diffusion loss that measures a fitness of the denoised state-action pair to a distribution of the expert behaviors,
computing a second diffusion loss that measures a fitness of the denoised state-action pair to a distribution of agent behaviors, and
computing the reward signal based on the first diffusion loss and the second diffusion loss.

10. The method of claim 9, wherein the reward signal is computed within a range bounded by a first value and a second value.

11. The method of claim 10, wherein the first value is indicative of a fitness to the distribution of the expert behaviors and the second value is indicative of a fitness to the distribution of the agent behaviors.

12. The method of claim 1, wherein the one or more policy parameters are updated to maximize the reward signal.

13. The method of claim 1, further comprising:
at the device, training the diffusion model.

14. The method of claim 13, wherein the diffusion model is trained on:
expert data that includes a set of expert data points, wherein each expert data point in the set of expert data points consists of expert state-action pairs each including a state and an action taken by an expert in the state, and
agent data that includes a set of agent data points, wherein each agent data point in the set of agent data points consists of agent state-action pairs each including a state and an action taken by an agent in the state.

15. The method of claim 14, wherein the diffusion model is trained to distinguish the expert data from the agent data.

16. The method of claim 15, wherein for each input expert state-action pair, the diffusion model generates a denoised expert state-action pair and:
a first diffusion loss is computed that measures a fitness of the denoised expert state-action pair to a distribution of the expert data,
a second diffusion loss is computed that measures a fitness of the denoised expert state-action pair to a distribution of the agent data, and
the first diffusion loss and the second diffusion loss are integrated to compute a value of the expert state-action pair within a range bounded by a first value and a second value,
wherein the first value is indicative of a fitness to the distribution of the expert data and the second value is indicative of a fitness to the distribution of the agent data.

17. The method of claim 16, wherein for each input agent state-action pair, the diffusion model generates a denoised agent state-action pair and:
a third diffusion loss is computed that measures a fitness of the denoised agent state-action pair to a distribution of the agent data,
a fourth diffusion loss is computed that measures a fitness of the denoised agent state-action pair to a distribution of the agent data, and
the third diffusion loss and the fourth diffusion loss are integrated to compute a value of the agent state-action pair within the range bounded by the first value and the second value.

18. The method of claim 17, wherein:
additionally for each input expert state-action pair:
an expert binary cross-entropy loss is computed from the value of the expert state-action pair, and
parameters of the diffusion model are updated based on the expert binary cross-entropy loss; and
additionally for each input agent state-action pair:
an agent binary cross-entropy loss is computed from the value of the agent state-action pair, and
the parameters of the diffusion model are updated based on the agent binary cross-entropy loss.

19. The method of claim 1, wherein the policy is trained for a single task.

20. The method of claim 1, wherein the policy is trained for a plurality of different tasks.

21. The method of claim 1, wherein the policy is trained for at least one robotics task.

22. The method of claim 1, wherein the policy is trained for at least one autonomous driving task.

23. The method of claim 1, further comprising, at the device:
deploying the trained policy for use by a downstream application to generate actions for given states.

24. The method of claim 23, wherein the downstream application includes a robotics application.

25. The method of claim 23, wherein the downstream application includes an autonomous driving application.

26. A system, comprising:
a non-transitory memory storage comprising instructions; and
one or more processors in communication with the memory, wherein the one or more processors execute the instructions to train a policy to imitate expert behaviors included in at least one expert demonstration by:
generating, by the policy, an action for an input state to generate a state-action pair;
processing the state-action pair, using a diffusion model, to generate a reward signal indicating a fitness of the state-action pair to the expert behaviors; and
updating, by the policy, one or more policy parameters based on the reward signal.

27. The system of claim 26, wherein the policy is a machine learning model.

28. The system of claim 26, wherein the at least one expert demonstration includes a recording of an expert performing a task.

29. The system of claim 26, wherein the policy is initialized prior to the training.

30. The system of claim 26, wherein the reward signal is generated by a diffusion discriminative classifier that includes the diffusion model.

31. The system of claim 30, wherein the reward signal is generated from a denoised state-action pair output by the diffusion model.

32. The system of claim 31, wherein the diffusion model forms the denoised state-action pair via a single step of a diffusion process.

33. The system of claim 26, wherein the policy is trained for at least one of:
at least one robotics task, or
at least one autonomous driving task.

34. A non-transitory computer-readable media storing computer instructions which when executed by one or more processors of a device cause the device to train a policy to imitate expert behaviors included in at least one expert demonstration by:
generating, by the policy, an action for an input state to generate a state-action pair;
processing the state-action pair, using a diffusion model, to generate a reward signal indicating a fitness of the state-action pair to the expert behaviors; and
updating, by the policy, one or more policy parameters based on the reward signal.

35. The non-transitory computer-readable media of claim 34, wherein the reward signal is generated by a diffusion discriminative classifier that includes the diffusion model.

36. The non-transitory computer-readable media of claim 35, wherein the reward signal is generated from a denoised state-action pair output by the diffusion model.

37. The non-transitory computer-readable media of claim 36, wherein the diffusion model forms the denoised state-action pair via a single step of a diffusion process.

38. The non-transitory computer-readable media of claim 34, wherein the policy is trained for at least one of:
at least one robotics task, or
at least one autonomous driving task.
